(19) United States
(12) Patent Application Publication
(10) Pub. No.: US 2007/0028049 A1
(43) Pub. Date: Feb. 1, 2007

(54) ID anti-collision method using data structure applied to RFID system

(75) Inventors: Jin-young Yang, Seoul (KR); Woo-shik Kang, Suwon-si (KR); Joon-goo Lee, Seoul (KR); Seon Wook Kim, Namyangju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/442,534

(22) Filed: May 30, 2006

(30) Foreign Application Priority Data
Jul. 26, 2005 (KR) 2005-0068107

(51) Int. Cl. G06F 12/00

(52) U.S. Cl. 711/122; 340/10.2

(57) ABSTRACT

An identification (ID) anti-collision method using a data structure to be applied to a radio frequency identification (RFID) system, includes transmitting an ID transmission request command from the reader to the tags using a predetermined request value; determining whether the IDs of the tags collide with one another, based on a bit pattern transmitted from the tags; if the IDs of the tags collide, computing a next request value to be used at a next request to transmit a request command, and if the IDs of the tags do not collide, computing and storing a future request value to be used; and if the IDs of the tags do not collide, transmitting and receiving data and a tag using an ID of the tag corresponding to the bit pattern and if the requested value is stored, transmitting a request command using the stored request value.

### CROSS-REFERENCE TO RELATED APPLICATIONS

This application claims the benefit of Korean Patent Application No. 10-2005-0068107 filed Jul. 26, 2005, in the Korean Intellectual Property Office, the disclosure of which is incorporated herein by reference in its entirety.

### BACKGROUND OF THE INVENTION

1. Field of the Invention

Methods consistent with the present invention relate to an identification (ID) anti-collision method using a data structure to be applied to a radio frequency identification (RFID) system, and more particularly, to an ID anti-collision method using a data structure to be applied to an RFID system capable of storing a request value to be used in a next request of a reader when a collision occurs during a tag's response to a request of the reader so as to reduce the number of requests of the reader.

2. Description of the Related Art

In the related art, radio frequency identification (RFID), as a kind of an automatic identification and data capture (AIDC) technology, reads data from a tag with a microchip using an RF in a non-contact way.

According to the related art RFID technology standards, a stationary reader continuously reads data from a plurality of tags. The RFID technology standards are suitable for a related art RFID system such as a supply chain management (SCM) system. However, in a case where the reader continuously reads the data from the plurality of tags, a tag ID collision occurs, and a battery of the reader is inefficiently consumed.

According to a time division multiple access (TDMA) method among multiple access methods such as a space division multiple access (SDMA) method, the TDMA method, a frequency division multiple access (FDMA) method, and a code division multiple access (CDMA) method, a bit-by-bit, a binary tree, a query tree, and the like are used to prevent such an ID collision.

FIGS. 1A and 1B are views illustrating an ID anti-collision method using a related art binary search algorithm applied to an RFID system.

FIG. 1A is a schematic view illustrating an ID anti-collision method using a related art binary search algorithm, and FIG. 1B is a view illustrating IDs of tags from which a reader desires to read data.

Referring to FIGS. 1A and 1B, if a reader transmits a request value REQ1 (1111) to read tags TAG1 (1011), TAG2 (1010), TAG3 (0011), and TAG4 (0101), a tag having an ID smaller than or equal to the request value REQ1 (1111) transmits the ID thereof. Thus, the tags TAG1, TAG2, TAG3, and TAG4 respond to a request command of the reader at the same time, and thus a tag ID collision occurs. In a case where a plurality of tags transmit tag IDs at the same time in responds to a command of the reader, “0” and “1” are received in the same bit position, and thus the reader cannot interpret transmitted data.

Even in a case where the reader transmits a request value REQ2 (0111), IDs of the tags TAG3 and TAG4 collide with each other. Thus, in a case where the reader transmits a request value REQ3 (0011), only the tag TAG3 having the ID with the same value as the request value REQ3 (0011) responds. Thus, the reader can transmit and receive data from the tag TAG3 using the ID of the tag TAG3 received from the tag TAG3.

In the related art ID anti-collision method, a request value REQ4 (1111) transmitted after the reader reads an ID of one of a plurality of tags is equal to the request value REQ1 (1111). Thus, when the tags TAG1, TAG2, and TAG4 except the tag TAG3, having responded to the request of the reader, respond to the request of the reader, the IDs of the tags TAG1, TAG2, and TAG4 collide with one another.

However, in a case where the reader uses the request value REQ2 (0111) used just before the request to which a tag has responded, but not the request value REQ4 (1111), the reader can receive a response of the tag TAG4 within a short time without a collision. In other words, in a case where the reader transmits “0111” as a request value instead of “1111,” tags having IDs smaller than or equal to the request value are TAG3 and TAG4. However, the tag TAG3 has already respond to the request, and thus, only the tag TAG4 responds to the request.

As described above, in the related art ID anti-collision method, a request command is executed using an inappropriate request value. Thus, the request command is required to be withdrawn to read a plurality of tags. As a result, the battery of the reader is unnecessarily consumed.

FIGS. 2A and 2B are views illustrating a related art search for a binary tree.

FIG. 2A illustrates a binary tree showing tag IDs to be read and an identifying order of the tag IDs, and FIG. 2B illustrates a method of identifying tag IDs using a related art binary tree. An example of a collision occurring when only tags having IDs smaller than or equal to a request value transmit the IDs in response to a request command is described below with reference to FIGS. 2A and 2B.

Referring to FIGS. 2A and 2B, in a case where tag IDs as shown in FIG. 2A are “0001,” “0100,” “0110,” “0111,” “1001,” “1010,” and “1111,” a method of identifying these tag IDs are described with reference to FIG. 2B.

As shown in FIG. 2B, a reader transmits a request command 17 times to read 7 tags. In a case where the reader determines a first request value as “1111” to transmit a request command to tags, seven tags having IDs equal to or smaller than the first request value “1111” respond to the request command at the same time. Thus, the IDs of the seven tags collide with one another.

The reader receives a collision bit pattern, keeps bits before a bit in which a collision occurs as they were received, and sets a bit in which a collision first occurs to “0” and bits after the bit “0” to “1”, based on the collision bit pattern to compute a new request value. In other words, a second request value is smaller than the first request value.

The reader receives a collision bit pattern “XXXX” with respect to a first request command and sets a first bit in which a collision occurs to “0” and bits after the bit “0” to “1” to compute a second request value “0111.”

In a case where the reader transmits the second request value “0111” with a second request command, IDs of tags on the left side of a tag D1 having a value smaller than or equal to the second request value “0111” collide with one another. IDs having values smaller than or equal to the second request value “0111” all have “0” in the first bit. Therefore, a collision does not occur in the first bit. Bits after the first bit have different bit values, and thus the collision bit pattern is “0XXX.”

Accordingly, the reader keeps the first bit before a collision occurs as “0” and determines a bit in which a collision first occurs as “0” and bits after the bit “0” as “1” using the collision bit pattern “0XXX” so as to determine a third request value as “0011.”

Tags having IDs with values smaller than or equal to the third request value “0011” are positioned on the left side of a tag D2. Since a tag having an ID with a value smaller than “0011” is only “0001,” a collision does not occur when the tag responds to the third request value “0011.” Thus, the reader transmits and receives data and a tag having an ID “0001” using the ID “0001” and transmits a command “mute” so that the tag having the ID “0001” does not respond to the request command.

After the reader reads one tag, a fourth request value is determined as “1111” equal to the first request value. Thus, the reader computes a new request value smaller than a previous request value from the fourth request value “1111” whenever a collision occurs, repeatedly transmits a request command using the new request value, and reads a tag having an ID “0100.” The reader reads the other tags using the same method by which the reader has read the tag having the ID “0001.”

In an anti-collision method using a binary search, when the number of tags is N, a minimum number of times a request command is transmitted to identify all of the tags is (2N−1). N times of “mute” commands for no response of a tag are required so that a tag identified at a next request after one tag is identified does not respond. Thus, a minimum number of commands of the reader for identifying all tags is (3N−1). However, in the case of the related art anti-collision method described with reference to FIGS. 2A and 2B, the number of tags is “7.” Thus, there are four unnecessary request commands for a minimum number of 13 request commands or 17 substantial request commands.

As described above, in the related art ID anti-collision method, the time required for identifying all of tags is increased with unnecessary requests of the reader. Thus, power consumption for the reader is increased. If the reader makes many requests, an amount of data transmitted between tags is increased. Thus, a number of transmission errors may be increased.

The time required for transmitting a request command one time and receiving a response to the request command is fixed. Thus, a method of reducing the number of requests may reduce the time required for identifying the all of the tags. Accordingly, an ID anti-collision method of reducing an amount of data transmitted between a reader and tags or the number of commands and responses for transmission to shorten the time required for identifying the tags is required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides an ID anti-collision method using a data structure to be applied to an RFID system capable of reducing the number of requests of a reader with respect to tags so as to shorten the time required for identifying all of the tags.

According to an aspect of the present invention, there is provided an ID anti-collision method applied to an RFID system comprising a reader comprising a data structure and a plurality of tags having IDs, including (a) transmitting an ID transmission request command from the reader to the tags using a request value; (b) determining whether the IDs of the tags collide with one another, based on a bit pattern transmitted from the tags; (c) if the IDs of the tags collide with one another, computing a next request value to be used at a next request to transmit a request command based on the bit pattern, and if the IDs of the tags do not collide with one another, computing and storing a future request value to be used; and (d) if the IDs of the tags do not collide with one another, transmitting and receiving data and a tag using an ID of the tag corresponding to the bit pattern and if the requested value is stored, transmitting a request command using the stored request value.

The future request value may be stored in a data structure using an LIFO (Last Input First Out) method.

The operation (d) may include transmitting and receiving data with respect the tag using the ID of the tag corresponding to the transmitted bit pattern; transmitting a mute command to the tag so that the tag does not respond to the request command; determining whether the request value is stored; and if the request value is stored, transmitting the request command using the stored request value, and if the request value is not stored, ending transmitting of the request command.

If the IDs of the tags are smaller than or equal to the request value of the request command, the tags may respond to the request command.

The next request value may be computed by determining a starting position of a bit of the bit pattern in which a collision occurs as “0,” a bit before the starting position as a bit value of the bit pattern, and a bit after the starting position as “1.”

The future request value may be computed by determining all of bits of the bit pattern in which collisions occur as “1” and bits in which collisions do not occur as a bit value of the bit pattern.

### BRIEF DESCRIPTION OF THE DRAWINGS

The above aspects and features will be more apparent by describing exemplary embodiments with reference to the accompanying drawings, in which:

FIGS. 1A and 1B are views illustrating an ID anti-collision method using a related art binary search algorithm applied to an RFID system;

FIGS. 2A and 2B are views illustrating a related art search for a binary tree;

FIG. 3 is a flowchart of an ID anti-collision method using a data structure to be applied to an RFID system according to an exemplary embodiment of the present invention;

FIGS. 4A through 4C are views illustrating an ID anti-collision method applied to a binary tree searching method according to an exemplary embodiment of the present invention;

FIGS. 5A through 5C are views illustrating an ID anti-collision method applied to a binary tree searching method using prefixing matching according to an exemplary embodiment of the present invention; and

FIGS. 6A through 6C are graphs illustrating results of a simulation executed to compare a performance of the ID anti-collision method of the exemplary embodiment with a performance of the related art ID anti-collision method.

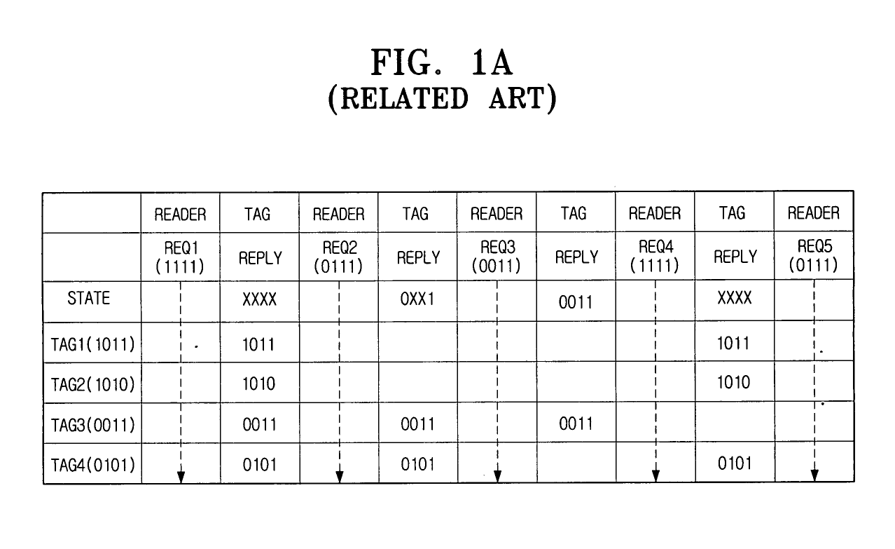

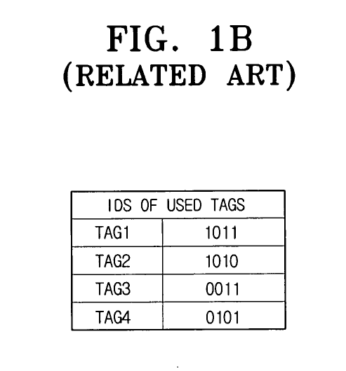

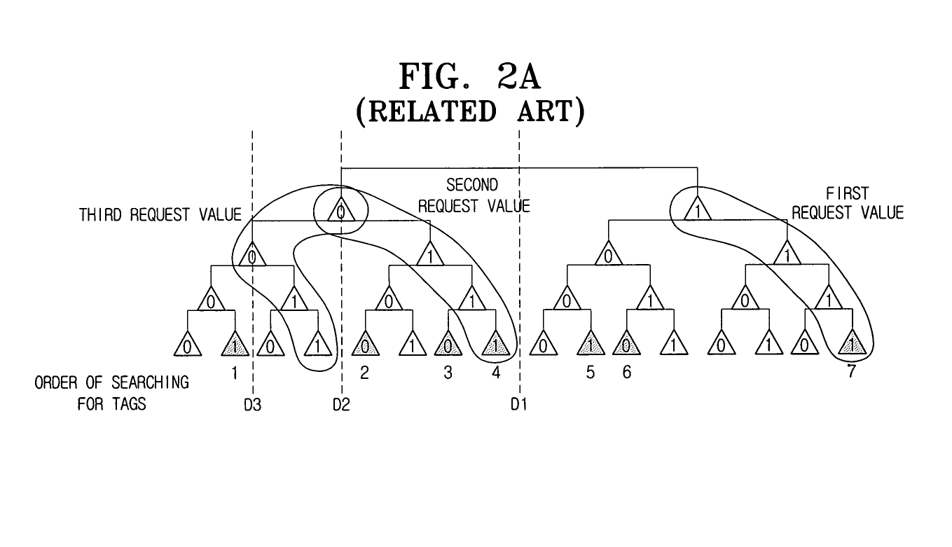

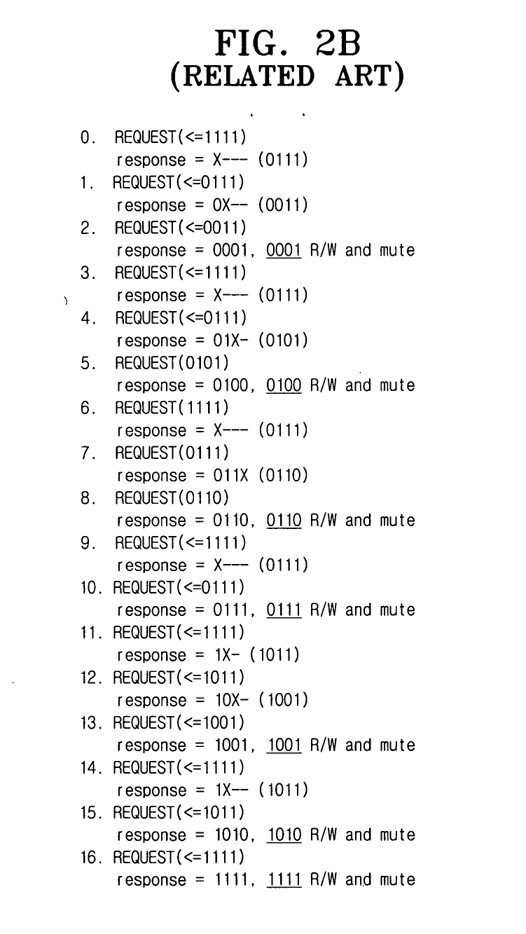

### DETAILED DESCRIPTION OF THE EXEMPLARY EMBODIMENTS

Exemplary embodiments of the present invention will be described in greater detail with reference to the accompanying drawings.

In the following description, same drawing reference numerals are used for the same elements, even in different drawings. The matters defined in the description such as a detailed construction and elements are provided to assist in a comprehensive understanding of the invention. However, the exemplary embodiments can be carried out without being limited thereto. Also, well-known functions or constructions are not described in detail for the sake of clarity.

Hereinafter, a case where a tag having an ID smaller than or equal to a request value responds to a request command of a reader to transmit a tag ID will be described.

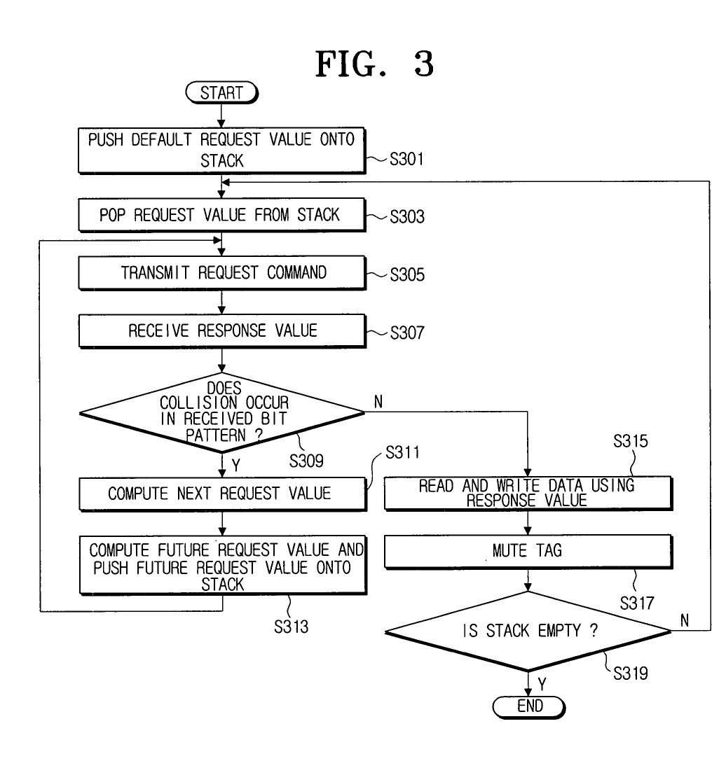

FIG. 3 is a flowchart of an ID anti-collision method using a data structure to be applied to an RFID system according to an exemplary embodiment. Referring to FIG. 3, in operation S301, a reader pushes a default request value to be used for a first tag ID transmission request command onto a stack. In a method of identifying tags using a binary tree search, the default request value is a maximum bit value of bits of a tag ID to which values of IDs of all tags respond. However, in a case where a tag having an ID greater than or equal to a request value responds to the tag ID transmission request command of the reader, the default request value may vary.

In operation S303, the reader pops the request value from the stack. Here, the request value is stored in a stack that is a data structure using a Last Input First Out (LIFO) method. Thus, the popped request value is a default request value lastly pushed onto the stack.

In operation S305, the reader transmits the tag ID transmission request command to a tag using the popped request value. In operation S307, the reader receives a response value from the tag having received the request value. Tags having received the request value compare their IDs with the request value. If the request value is smaller than or equal to the IDs of the tags, the tags transmit their IDs in response to a request command.

In operation S309, the reader determines whether tag IDs collide with one another, based on a received bit pattern that is a response value. In a case where there are a plurality of tags having IDs smaller than or equal to the request value of the reader, the tags respond to the request command of the reader substantially simultaneously. Thus, the reader cannot read bits of the received bit pattern in which collisions occur due to the collisions of the tag IDs.

For example but not by way of limitation, in a case where a request value is “0111” and first and second tags having IDs “0110” and “0101” equal to or smaller than the request value “0111” exist, the first and second tags respond to the request of the reader at the substantially same time. First and second bits of IDs of the first and second tags have the same bit value and thus do not collide with each other. However, third and fourth bits have different bit values and collide with each other. Thus, a bit pattern of a response value received by the reader is “01XX.”

If the tag IDs collide with one another, in operation S311, a next request value to be used for a next request command is computed. The next request value is computed by determining a starting position of a bit of the received bit pattern in which a collision occurs as “0”, a bit before the starting position as a bit value of the received bit pattern, and the other bits after the starting position as “1.”

In operation S313, the reader computes a future request value to be used when the tag IDs do not collide with one another and pushes the future request value onto the stack. The future request value is computed by determining bits of the received bit pattern in which a collision occurs as “1” and bits in which a collision does not occur as a bit value of the received bit pattern.

Here, orders of operations S311 and S313 may be switched. After the reader computes the next and future request values, the reader returns to operation S305 to compute a next request value so as to transmit the tag ID transmission request command to the tag using the next request value.

If the tag IDs do not collide with one another in operation S309, the reader transmits data and receives data and a tag having responded to the request command using an ID of the tag in operation S315.

In operation S317, the reader transmits a “mute” command to a tag having responded to the request command, so that the tag does not respond to the request command.

In operation S319, the reader determines whether the stack stores a future request value. If the reader determines in operation S319 that the stack stores the future request value, the reader returns to operation S303 to pop the future request value to transmit the tag ID transmission request command using the popped future request value. If the reader determines in operation S319 that the stack does not store the future request value, the reader determines that the reader has identified all of the tag IDs to end the process.

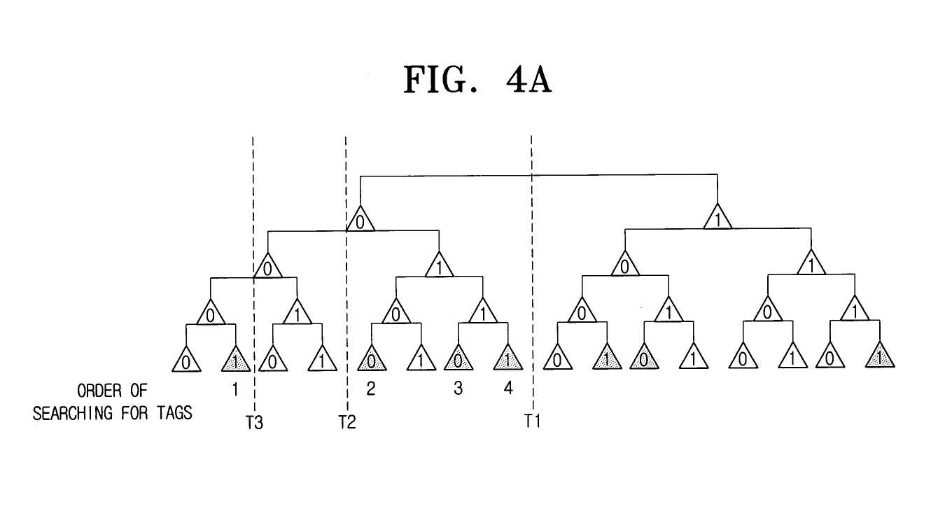

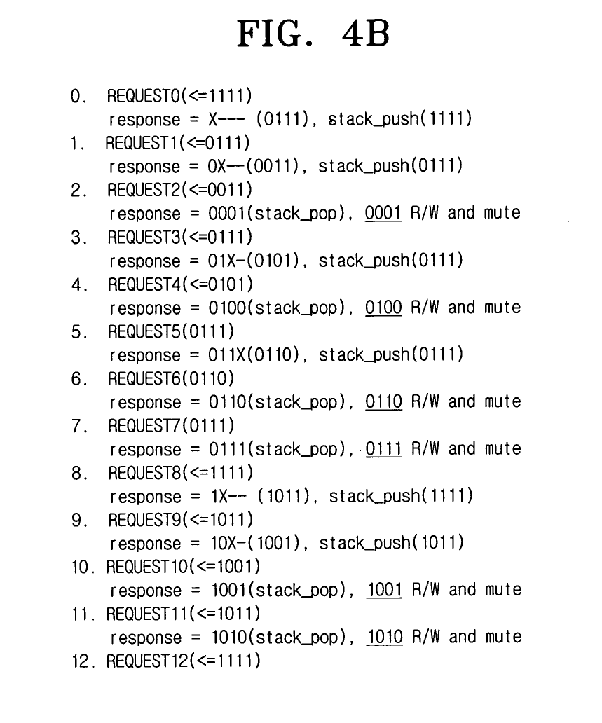

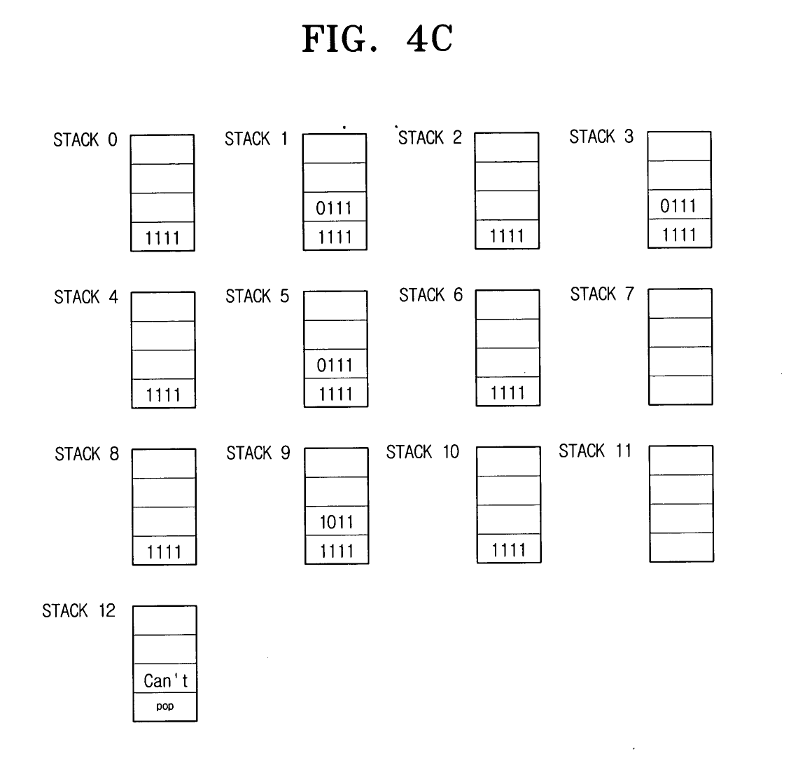

FIGS. 4A through 4C are views illustrating an ID anti-collision method applied to a binary tree search method according to an exemplary embodiment.

FIGS. 4A through 4C are views illustrating the ID anti-collision method of FIG. 3 in detail. FIG. 4A is a view illustrating a binary tree showing tag IDs to be read and an order of identifying the tag IDs. FIG. 4B is a view illustrating a method of identifying the tag IDs using a stack in detail according to an exemplary embodiment, and FIG. 4C is a view illustrating a stack storing a future request value used in the exemplary embodiment.

In a case where seven tag IDs are “0001,” “0100,” “0110,” “0111” “1001,” “1010,” and “1111” as shown in FIG. 4A, an order of identifying the seven tag IDs will be described with reference to FIGS. 4B and 4C.

Referring to FIGS. 4B and 4C, a default request value “1111” to be used when a reader transmits a tag ID transmission request command is pushed onto a stack.

Also, the reader pops the default request value “1111” in REQUEST0 to transmit a request command for reading a plurality of tag IDs. Since seven tag IDs have value smaller than or equal to the default request value “1111,” the seven tag IDs collide with one another. Thus, a received bit pattern is “XXXX.”

A collision occurs in the bit pattern received for REQUEST0 in operation S309, and a next request value is accordingly computed using the received bit pattern in operation S311. A request value to be used in REQUEST 1 is computed by determining a starting position of a bit of the received bit pattern in which a collision occurs as “0”, a bit before the starting position as a bit value of the received bit pattern, and the other bits after the starting position as “1” as described in operation S311. Thus, since a collision occurs in a first bit position of the received bit pattern “XXXX,” a next request value computed by determining a first bit as “0” and the other bits as “1” is “0111.”

A future request value to be used when a collision does not occur in the received bit pattern is computed by determining bits of the bit pattern in which collisions occur as “1” and bits in which collision do not occur as a bit value of the bit pattern as described in operation S313.

Thus, a future request value computed by determining bits after a first bit of the received bit pattern “XXXX” in which a collision occurs as “1” is “1111.” The computed future request value is pushed onto the stack so as to be used when a collision does not occur in the received bit pattern. Thus, a stack after REQUEST0 is equal to STACK0 of FIG. 4C storing the computed future request value.

Since the collision occurs in the received bit pattern, the reader returns to operation S305 to transmits a request command REQUEST1 using the next request value “0111.” If the request value is “0111,” tags having IDs smaller than or equal to the request value “0111” and positioned on the left side of a tag T1 respond to the request command. Since the tags have IDs “0001,” “0100,” “0110,” and “0111,” a collision occurs from a second bit, and thus the received bit pattern is “0XXX.”

A next request value and a future request value for a request command REQUEST 1 are computed using the received bit pattern according to the method by which the next and future request values have been computed for the request command REQUEST0. Thus, the next request value and the future request value computed with respect to the request command REQUEST1 are respectively “0011” and “0111.” Here, the future request value is pushed onto the stack, and a stack after the request command REQUEST1 is equal to STACK1 of FIG. 4C.

Since a collision occurs in the received bit pattern with respect to the request value “0111” used for the request command REQUEST 1, the reader transmits a request command REQUEST2 using the next request value “0011” computed by returning to operation S305. If the request value “0011,” tags positioned on the left side of a tag T2 having an ID smaller than or equal to the request value “0011” respond to the request command. Thus, only a tag having an ID “0001” responds to the request command, and thus a collision does not occur and the received bit pattern “0001.” The reader transmits data and receives data and a tag having an ID “0001” using the tag ID “0001” that is the received bit pattern.

The collision does not occur in the received bit pattern with respect to the request command REQUEST2 in operation S309. Thus, the future request value pushed onto the stack in operation S315 is popped. The popped future request value is the last pushed future request value “0111” of the pushed future request values “0111” and “1111.” Since the popped request value “0111” is deleted, the stack is equal to STACK2 of FIG. 4C storing only the request value “1111.”

Thus, the reader transmits a request command REQUEST3 using the popped request value “0111.” Tags having IDS smaller than or equal to the request value “0111” are “0111,” “0110,” and “0100”, positioned on the left side of the tag T1.

Here, as in the related art ID anti-collision method, a tag ID is received, and then a request command is transmitted using the future request value “0111” computed in the request command REQUEST2 and pushed onto the stack not maximum bit values “1111” of the tag ID. In other words, one tag ID is received, and then a request command is transmitted using a binary value of an upper tree of a tag ID having responded to a request value.

Therefore, collisions occur only in IDs “0100,” “0110,” and “0111” of tags, except tags having responded to the request command REQUEST1 before the request command REQUEST2. However, the request value is determined as “1111” after the request command to which tags respond, so that the IDs are “0100,” “0110,” “0111,” “1001,” “1010,” and “1111” of tags except tags having responded to collide with one another. An ID “0100” of a net tag having responded to the request command can be received using a “small” request command.

The other tags can be identified after the request command REQUEST3 using the substantially same method by which tags are identified using the request commands REQUEST0, REQUEST1, and REQUEST2. Thus, the tag ID transmission request command can be transmitted 13 times to identify all of seven tags. A minimum number of times request command is transmitted is “13” when the number of tags is “7.” The minimum number of times is reduced as compared with the related art ID anti-collision method.

A stack data structure storing a next request value is realized by a reader and has a simple format storing data on the next request value. Here, a size of the stack data structure is a depth of an entire stack pool for identifying one tag. In other words, when a maximum value of a tag to be identified is M, a size S of a necessary stack is S=log₂M. For example, if size of a stack is “10,” the number of tags to be identified is “1024.”

A binary search is performed from a small tag ID as shown in FIG. 4A, and a default request value is a value allowing all of tags to respond to a request command. Thus, although other tags are dynamically added during identifying of a tag, all of the added tags can be identified.

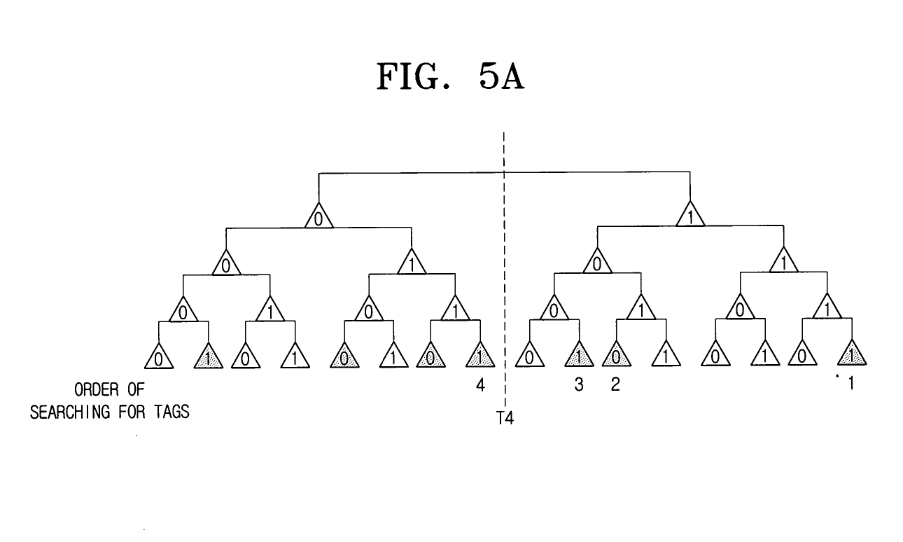

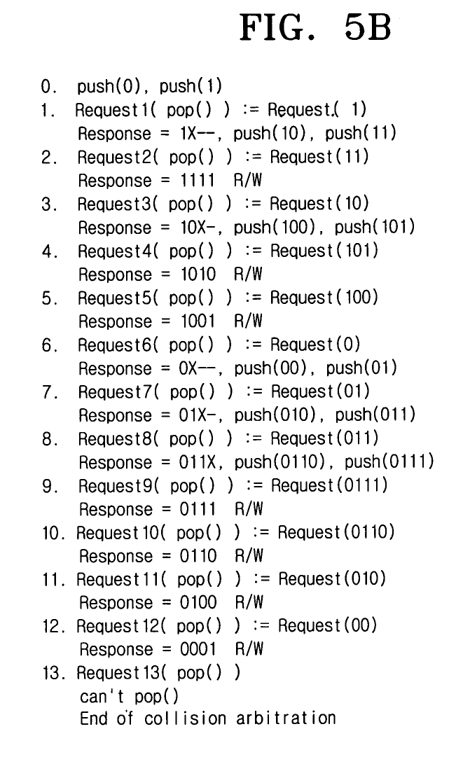

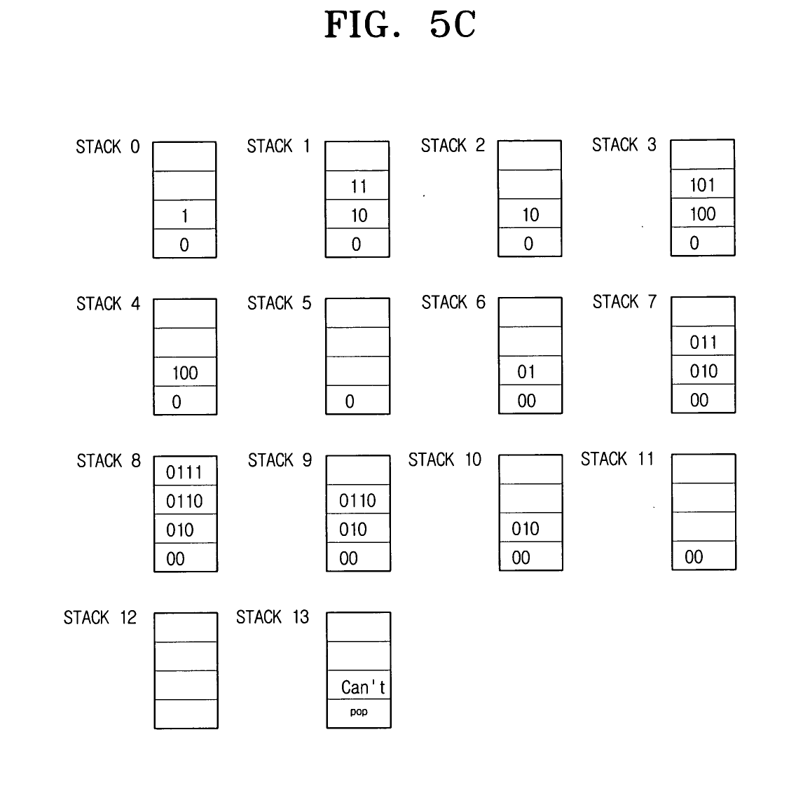

FIGS. 5A through 5C are views illustrating an ID anti-collision method applied to a binary tree searching method using a prefix matching according to another exemplary embodiment.

FIGS. 5A through 5C are views illustrating the ID anti-collision method of FIG. 3 in detail. FIG. 5A illustrates a binary tree showing tag IDs to be identified and an order of identifying the tag IDs. FIG. 5B is a view illustrating a method of identifying tag IDs using a stack in detail according to the exemplary embodiment, and FIG. 5C is a view illustrating a stack storing a next request value used in the exemplary embodiment.

In a case where seven tag IDs are “0001,” “0100,” “0110,” “0111,” “1001,” “1010,” and “1111” as shown in FIG. 5A, an order of reading the tag IDs is substantially similar to the order in the method described with reference to FIGS. 4B and 4C. In the method described with reference to FIGS. 4A through 4C, a tag having an ID with a value smaller than or equal to a request value responds to a request command of the reader. However, in the method shown in FIGS. 5A through 5C, a tag having an ID with a bit value equal to a request value responds to a request command. Thus, compared to the method described with reference to FIGS. 4A through 4C, a request value stored in a stack may vary, and an order of identifying tags may vary.

Describing the ID anti-collision method with reference to FIGS. 5B and 5C, “0” and “1” as default request values are pushed onto a stack. A reader pops “1” lastly stored in the stack as a request value to transmit a request command REQUEST0. Tags having IDs with first bit values “1” respond to the request command REQUEST0. Thus, tags on the right side of a tag T4 respond to the request command REQUEST0, and a received bit pattern is “1XXX” as shown in FIG. 5A.

After a response to the request command REQUEST0 is received, a future request value to be used when IDs do not collide with one another in the received bit pattern is computed using a method similar to the above-described method. A bit value before a starting position of the received bit pattern in which a collision occurs is kept as it is, and bit values after the starting position are “0” and “1.” Thus, future request values computed after the request command REQUEST0 are “10” and “11” and pushed onto the stack. The stack after the request command REQUEST0 is equal to STACK0 shown in FIG. 5C.

Referring to FIGS. 4A through 4C, a next request value is computed by keeping a bit value before a bit of the received bit pattern in which a collision occurs as it is and determining the bit in which the collision occurs as “1.” Thus, the computed next request value is “11.”

Since the collision occurs in the request command REQUEST0 in operation S309, the next request value “11” is determined as a request value to transmit the request command REQUEST1 in operation S305. A method of identifying tags after the request command REQUEST1 is substantially similar to the method described with reference to FIGS. 4A through 4C.

The ID anti-collision method applied to the binary tree searching method using the prefix matching also requires 13 request commands to identify seven tags. Thus, the number of request commands for identifying all of tags is a minimum number of request commands more reduced than in the ID anti-collision method.

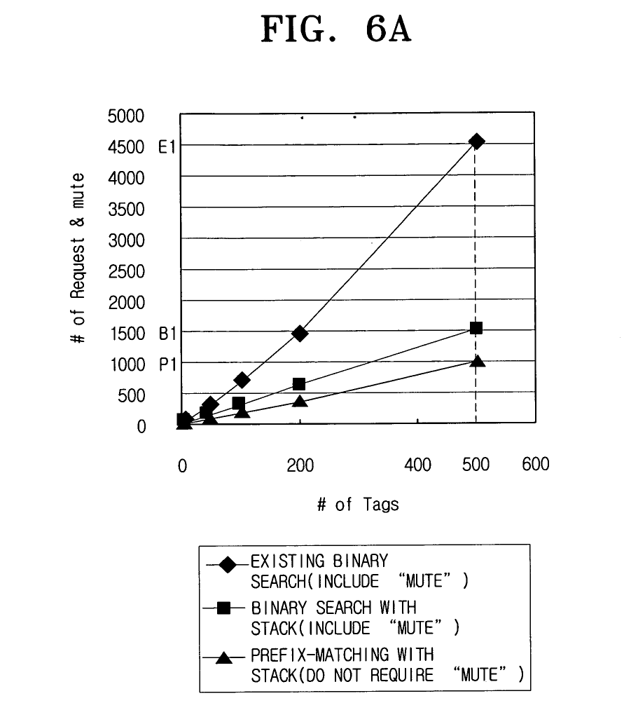

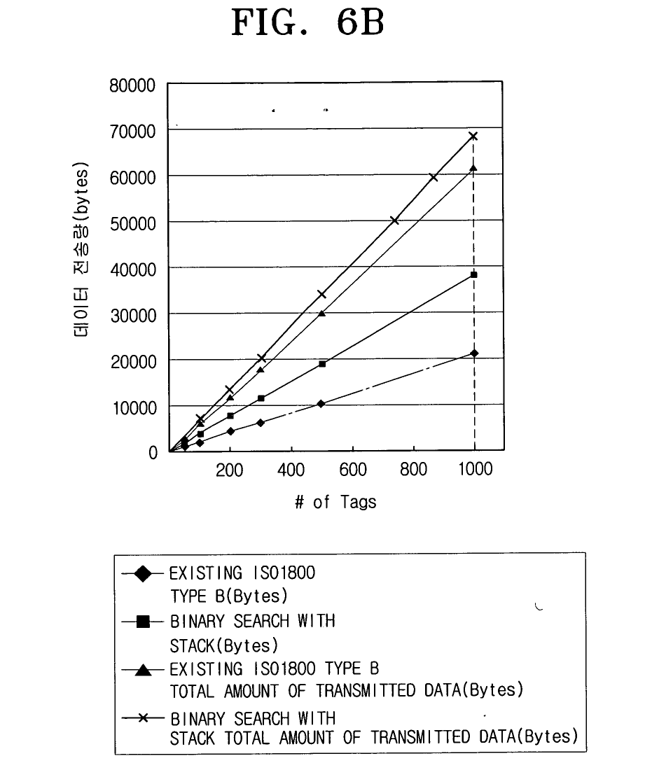

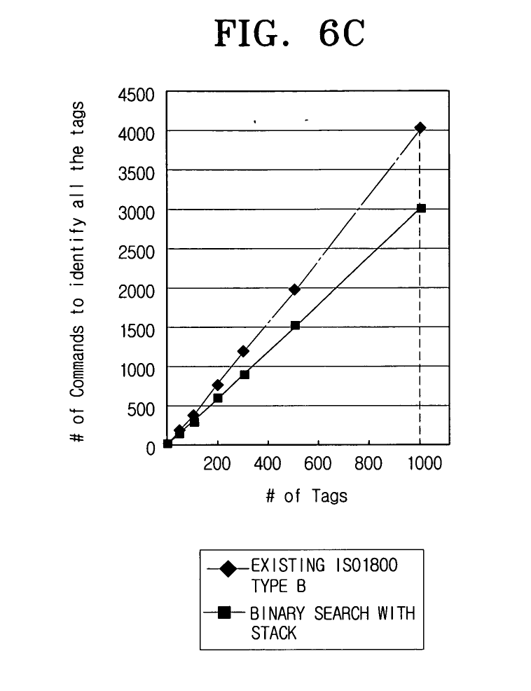

FIGS. 6A through 6C are graphs illustrating results of a simulation performed to compare a performance of the ID anti-collision method of the exemplary embodiment with a performance of the related art ID anti-collision method.

FIG. 6A is a graph illustrating relationships between numbers of tags and numbers of request commands of readers in the related art ID anti-collision method and the ID anti-collision method of the exemplary embodiment, and FIG. 6B is a graph illustrating relationships between numbers of tags and commands of readers including mute commands in the related art ID anti-collision method and the ID anti-collision method of the exemplary embodiment. FIG. 6C is a graph illustrating relationships between numbers of tags and amounts of transmitted data in the related art ID anti-collision method and the ID anti-collision method of the exemplary embodiment.

As shown in FIG. 6A, in a case where the ID anti-collision method of the exemplary embodiment is applied, the number of request commands and mute commands for identifying 500 tag IDs is “1499.” However, in a case where the related art ID anti-collision method is applied, the number of request commands and mute commands for identifying 500 tag IDs is about “4500.” Also, in a case where the ID anti-collision method using prefix matching is applied, the number of request commands except mute commands for identifying 500 tag IDs is about “1000.” Thus, in a case where the ID anti-collision method of the exemplary embodiment is applied, the number of request commands for identifying all of tags is substantially reduced with respect to the related art ID anti-collision method.

As shown in FIG. 6A, a tag ID is 30 bits and randomly generated, and a distribution of the tag IDs is substantially uniform. It is supposed that tags are identified using the method described with reference to FIG. 3, and transmitted bits may not have errors caused by noise or the like.

As shown in FIGS. 6B and 6C, in a case where the ID anti-collision method of the exemplary embodiment is applied, the number of request commands including the mute commands and an amount of transmitted data are more reduced than when the related art ID anti-collision method is applied. Here, a tag ID is 64 bits, 40 bits of which are randomly generated and 18 bits of which are generated according to ISO, and a distribution of the tag ID is uniform. As described with reference to FIG. 6A, it is supposed that tags are identified using the method described with reference to FIG. 3, and transmitted bits may not have errors caused by noise or the like.

As described above, according to the exemplary embodiments, a request value used to transmit a tag ID transmission request command of a reader can be stored and used. Thus, the number of request commands of the reader can be reduced to shorten the time required for identifying all of tags. As a result, battery consumption of the reader can be reduced.

Additionally, the foregoing methods of the exemplary embodiments may be implemented in a computer readable medium, or a data carrier. More specifically, the computer-readable medium includes a set of instructions (e.g., computer program). The instructions include the operations discussed with respect to the foregoing methods. As a result, the present invention can be implemented as software, in addition to the foregoing disclosure.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An identification (ID) anti-collision method for a radio frequency identification (RFID) system including a reader having a data structure and a plurality of tags having IDs, the ID anti-collision method comprising:
(a) transmitting an ID transmission request command from the reader to the tags using a request value;
(b) determining whether the IDs collide with one another based on a bit pattern transmitted from the tags;
(c) if the IDs of the tags collide with one another, computing a next request value for a next request based on the bit pattern to transmit a request command, and computing and storing a future request value; and
(d) if the IDs of the tags do not collide with one another, transmitting and receiving data and a tag using an ID of the tag corresponding to the bit pattern, and if the request value is stored, transmitting the request command using the future request value that was previously stored.

2. The ID anti-collision method of claim 1, wherein the future request value is stored in a data structure using an LIFO (Last Input First Out) method.

3. The method of claim 2, wherein a data structure corresponding to the LIFO method is a stack.

4. The method of claim 3, wherein a size S of the stack is equal to log₂M and M is a maximum value of a tag to be identified.

5. The ID anti-collision method of claim 1, wherein (d) comprises:
transmitting and receiving the data with respect to the tag using the ID of the tag corresponding to the transmitted bit pattern;
transmitting a mute command to the tag so that the tag does not respond to the request command;
determining whether the future request value was previously stored; and
if the future request value was previously stored, transmitting the request command using the stored future request value, and if the future request value is not stored, ending transmitting of the request command.

6. The ID anti-collision method of claim 1, wherein if the IDs of the tags are smaller than or equal to the request value of the request command, the tags respond to the request command.

7. The ID anti-collision method of claim 6, wherein the next request value is computed by determining a starting position of a bit of the bit pattern in which a collision occurs as “0,” a bit before the starting position as a bit value of the bit pattern, and a bit after the starting position as “1.”

8. The ID anti-collision method of claim 6, wherein the future request value is computed by determining all bits of the bit pattern in which collisions occur as “1” and bits of the bit pattern in which collisions do not occur as a bit value of the bit pattern.

9. A computer-readable medium for storing a program for identification (ID) anti-collision for a radio frequency identification (RFID) system including a reader having a data structure and a plurality of tags having IDs, the program comprising:
(a) transmitting an ID transmission request command from the reader to the tags using a request value;
(b) determining whether the IDs collide with one another based on a bit pattern transmitted from the tags;
(c) if the IDs of the tags collide with one another, computing a next request value for a next request based on the bit pattern to transmit a request command, and computing and storing a future request value; and
(d) if the IDs of the tags do not collide with one another, transmitting and receiving data and a tag using an ID of the tag corresponding to the bit pattern, and if the request value is stored, transmitting the request command using the future request value that was previously stored.

10. The computer-readable medium of claim 9, wherein the future request value is stored in a data structure using an LIFO (Last Input First Out) method.

11. The computer-readable medium of claim 10, wherein a data structure corresponding to the LIFO method is a stack.

12. The computer-readable medium of claim 11, wherein a size S of the stack is equal to log₂M and M is a maximum value of a tag to be identified.

13. The computer-readable medium of claim 9, wherein the operation (d) comprises:
transmitting and receiving the data with respect to the tag using the ID of the tag corresponding to the transmitted bit pattern;
transmitting a mute command to the tag so that the tag does not respond to the request command;
determining whether the future request value was previously stored; and
if the future request value was previously stored, transmitting the request command using the stored future request value, and if the future request value is not stored, ending transmitting of the request command.

14. The computer-readable medium of claim 9, wherein if the IDs of the tags are smaller than or equal to the request value of the request command, the tags respond to the request command.

15. The computer-readable medium of claim 14, wherein the next request value is computed by determining a starting position of a bit of the bit pattern in which a collision occurs as “0,” a bit before the starting position as a bit value of the bit pattern, and a bit after the starting position as “1.”

16. The computer-readable medium of claim 14, wherein the future request value is computed by determining all bits of the bit pattern in which collisions occur as “1” and bits of the bit pattern in which collisions do not occur as a bit value of the bit pattern.
